(19) United States
(12) Patent Application Publication
(10) Pub. No.: US 2019/0022862 A1
(43) Pub. Date: Jan. 24, 2019

(54) POSITION DEFINITION IN COORDINATE SYSTEM OF A ROBOT BY DEVICE PLACEMENT

(71) Applicant: SONY MOBILE COMMUNICATIONS INC., TOKYO (JP)

(72) Inventors: Hannes BERGVIST, HELSINGBORG (SE); Mattias FALK, LUND (SE)

(21) Appl. No.: 16/081,448

(22) PCT Filed: Aug. 11, 2016
(86) PCT No.: PCT/EP2016/069168

§ 371 Date: Aug. 31, 2018

(30) Foreign Application Priority Data
Mar. 7, 2016 (EP) 16159009.6

(51) Int. Cl. B25J 9/16; B25J 19/02; G01S 5/14

(52) U.S. Cl. CPC B25J 9/1664; G01S 5/14; B25J 19/026; B25J 19/027

(57) ABSTRACT

A first device is mounted on a robot, and signals are transmitted between the first device and at least one second device placed at a certain physical location. Based on the signals, one or more positions in a coordinate system of the robot are determined. For this purpose, the robot may move the first device so that the signals can be transmitted for different physical locations of the first device.

### FIELD OF THE INVENTION

The present invention relates to methods for and to corresponding devices and systems.

### BACKGROUND OF THE INVENTION

In the field of robotics, it is known to control operation of a robot, e.g., an industrial robot as used in manufacture or packaging of a product, based on positions and/or orientations defined in a well-defined coordinate system used by the robot. For example, such positions may be used for driving a robotic arm to a desired target position, so that a product can be picked up by the robotic arm.

These positions may also correspond to positions of work objects. Further, these positions may correspond to intermediate positions and/or boundary positions for controlling movement of the robot. The positions can be defined by jogging, i.e., by manually moving the robot with a joystick, by offline tools, e.g., by means of simulated environments, or with the aid of computer vision systems, e.g., by using cameras and ad-hoc algorithms.

However, the above known methods may suffer from several problems: For example, jogging is time consuming and can only be used for predefined positions. Offline tools require creating a model, which may be a complex and time demanding task. Computer vision systems are dependent on lighting, line of sight conditions, or the like.

Accordingly, there is a need for technologies which overcome the above-mentioned problems and allow for efficiently defining positions in a coordinate system used by a robot.

### SUMMARY OF THE INVENTION

According to an embodiment, a method of defining one or more positions in a coordinate system of a robot is provided. According to the method, a first device is mounted on the robot, and signals are transmitted between the first device and at least one second device placed at a certain physical location. The signals may comprise ultrasonic signals, radio signals, and or radar signals. Based on the signals, the one or more positions in the coordinate system of the robot are determined. Accordingly, the position(s) can be easily defined in an intuitive manner by placing one or more physical object(s), i.e., the second device(s), at a desired location. This may for example involve attaching or otherwise associating the second device(s) to one or more objects.

The at least one second device may comprise one or more beacons which transmit the signals and each can be placed at a desired physical location. The first device may then comprise a receiver for receiving the signals from the one or more beacons. In other scenarios, the first device could comprise a transmitter for sending the signals, and the at least one second device, or each of multiple second devices, could comprise a receiver for receiving the signals from the first device.

According to an embodiment, the robot is operated to place the first device at multiple different physical locations. In this case, the signals may be transmitted for each of the different locations of the first device. In the above-mentioned scenario where the at least one second device comprises one or more beacons and the first device comprises a receiver for receiving the signals from the one or more beacons, the receiver may receive signals transmitted by the one or more beacons for each of the different locations of the first device. The one or more positions in the coordinate system of the robot may then be determined based on the signals received for the different locations of the first device. For example, this may involve that for each of the different locations of the first device the signals are evaluated to determine a distance between the first device and the at least one second device. The one or more positions in the coordinate system of the robot can then be determined based on the distances evaluated for the different locations of the first device. This allows for efficiently determining the position(s) by triangulation and/or trilateration.

According to an embodiment, the signals received for the different locations of the first device may also be used as a basis for determining an orientation of an object in the coordinate system of the robot.

According to an embodiment, the method may also comprise determining an angle at which the signals are transmitted between the first device and the at least one second device. In the above-mentioned scenario where the at least one second device comprises one or more beacons and the first device comprises a receiver for receiving the signals from the one or more beacons, the angle may correspond to an angle at which the receiver receives the signals from the at least one beacon. The angle may for example be measured by using directional reception functionalities of the receiver. The one or more positions in the coordinate system of the robot may then be determined based on the angle. By utilizing the angle, a reduced number of different locations of the first device is sufficient to determine the position(s) in the coordinate system of the robot.

According to an embodiment, an orientation of the at least one second device in the coordinate system of the robot can be determined based on measurements by an orientation sensor of the at least one second device. This orientation of the at least one second device may then in turn be used for determining an orientation of an object in the coordinate system of the robot.

According to a further embodiment, system is provided. The system comprises a first device mounted on a robot and configured for transmission of signals between the first device and at least one second device placed at a certain physical location. The signals may comprise ultrasonic signals, radio signals, and or radar signals. Further, the system comprises at least one processor configured to determine, based on the signals, one or more positions in the coordinate system of the robot. The at least one processor may be part of the first device. However, the at least one processor could also be part of an external controller for of the robot or part of the at least one second device. In some scenarios, the determination of the one or more positions could also be accomplished by cooperation of multiple processors. For example, one or more of these multiple processors could be part of the first device, and one or more of these multiple processors could be part of an external controller or of the robot and/or part of the at least one second device. Accordingly, in some embodiments the first device and the at least one processor are part of the same device, while in other embodiments the at least one processor is part of another device or at least one of multiple processors used for determining the one or more positions is part of another device, e.g., part of an external controller or of the robot and/or part of the at least one second device. According to an embodiment, the system further comprises the at least one second device.

In the above-mentioned system, the at least one second device may comprise one or more beacons each comprise a transmitter for sending the signals and each can be placed at a desired physical location. The first device may then comprise a receiver for receiving the signals from the one or more beacons. In other scenarios, the first device could comprise a transmitter for sending the signals, and the second device, or each of multiple second devices, could comprise a receiver for receiving the signals from the first device.

The at least one processor of the system may be configured to perform or control the steps of a method according to the above embodiment.

Accordingly, in some embodiments the at least one processor may be configured to operate the robot to place the first device at multiple different physical locations, so that for each of the different locations the first device the signals are between the first device and the at least one second device, and determine the one or more positions in the coordinate system of the robot based on the signals transmitted for the different locations of the first device

In some embodiments the at least one processor may be configured to evaluate, for each of the different locations of the first device, a distance between the first device and the at least one second device and determine the one or more positions in the coordinate system of the robot based on the distances evaluated for the different locations of the first device.

In some embodiments the at least one processor may be configured to determine an orientation of an object in the coordinate system of the robot based on the signals transmitted for the different locations of the first device.

In some embodiments the at least one processor may be configured to determine an angle at which the signals are transmitted between the first device and at least one second device and determine the one or more positions in the coordinate system of the robot based on the angle.

In some embodiments the at least one processor may be configured to determine an orientation of the at least one second device in the coordinate system of the robot based on measurements by an orientation sensor of the at least one second device.

In the above embodiments of the method or system, the one or more positions may comprise a position of an object. In addition or as an alternative, the one or more positions may comprise a target position for the robot. In addition or as an alternative, the one or more positions comprise a position to be avoided by the robot. Accordingly, various kinds of positions which may be relevant for operation of the robot may be defined by placing the at least one second device.

The above and further embodiments of the invention will now be described in more detail with reference to the accompanying drawings.

### BRIEF DESCRIPTION OF THE DRAWINGS

FIG. 1 schematically illustrates a robotic system according to an embodiment of the invention.

FIG. 2 schematically illustrates a use case in which beacons are used to define the position of an object.

FIG. 3 schematically illustrates an exemplary scenario in which positions are defined by two beacons, using measurements in multiple different positions of a receiver.

FIG. 4 schematically illustrates an example of processes performed in the scenario of FIG. 3.

FIG. 5 shows a flowchart for illustrating a method according to an embodiment of the invention.

FIG. 6 schematically illustrates a processor-based implementation of a receiver according to an embodiment of the invention.

FIG. 7 schematically illustrates a processor-based implementation of a beacon according to an embodiment of the invention.

### DETAILED DESCRIPTION OF EMBODIMENTS

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments described hereinafter.

The illustrated embodiments relate to operation of a robot, e.g., an industrial robot to be used for manufacturing or packaging of a product. The robot may be a static robot or a mobile robot. A static robot may be statically mounted and include a robotic arm or similar moveable part. A mobile robot may move in its entirety. However, it is also conceivable that the robot is a mobile robot and further includes a robotic arm or similar moving part.

An exemplary system according to an embodiment thus includes a robot. Further, the system includes at least one receiver unit mounted on a known position of the robot, e.g., on a robotic arm of the robot. The receiver may be integrated with the robot. However, it is also conceivable that the receiver is a separate device which can be retrofitted to the robot. Further, the system includes at least one transmitter unit (in the following also referred to as beacon). The at least one beacon is configured to transmit signals to be received by the receiver. On the basis of the signals, the position of the at least one beacon can be determined in a coordinate system of the robot.

Accordingly, one or more of these beacons can be used to define one or more positions in the coordinate system of the robot. These one or more positions can then be used for controlling operation of the robot. For example, the positions may be used for driving a robotic arm of the robot (or similar moveable part of the robot) or the entire robot to a desired target position. These positions may also correspond to positions of work objects. Further, these positions may correspond to intermediate positions and/or boundary positions for controlling movement of the robot or parts thereof. The at least one beacon may this be used to define various types of positions in coordinate system of the robot.

The at least one beacon may be associated (e.g., attached) to an object which is placed in proximity of the robot. The location of the object may for example be such that movements of the robot or movements of a moveable part of the robot can reach the location of the object. In other words, the object may be located within a cell of the robot. For example, the object could be a box and the beacon(s) could be attached to the box. In this scenario, the robot could be operable to pick up a part and put it into the box.

An exemplary method according to an embodiment involves moving the robot so that the receiver is placed at multiple different physical locations. For example, the robot may be moved from its original, known position to at least two other known positions or to at least other two positions that can be calculated from the geometry of the robot, e.g., the length of a robotic arm or similar moveable part of the robot. Further, the method involves measuring the distance between the at least one beacon and the receiver for each of the different positions, so as to determine the position of the beacon. For example, the position of the beacon can be determined by triangulation and/or trilateration based on distance-related measurements, such as received signal strength measurements, obtained for the different locations of the receiver.

For defining the positions in the coordinate system of the robot, an operator of the robot may place the at least one beacon at a desired physical location.

For example, the position of a beacon may represent an entry position of a machine, a position the robot has to avoid, a target position where the robot should pick up some parts, a position where the robot should release a picked up part, or the like. Further, the position of a beacon may represent an intermediate position in the course of a movement performed by the robot. Further, the positions of one or more beacons may be used to define boundary positions for limiting movement of the robot (e.g., in order to meet safety requirements).

The positions may be used for controlling movement of the robot. As used herein, movement of the robot is intended to cover movement of the robot in its entirety and movement of one or more movable parts of the robot, such as an robotic arm.

In some scenarios, two or more beacons may be attached or otherwise associated to the same object. In this case, measurements with respect to these multiple beacons may be combined to determine the position of the object, e.g., by averaging. Further, an orientation of the object may be determined. For example, if two beacons are attached or otherwise associated to the object, a two-dimensional (2D) orientation of the object can be calculated. If three beacons are attached or otherwise associated to the object, a three-dimensional (3D) orientation of the object can be calculated. In some scenarios, measurements with respect to the multiple beacons may also be used to determine one or more dimensions of the object (e.g., in terms of width, length, or height).

In some scenarios, the receiver may include two or more antennas. This may allow for reducing the required number of different locations of the receiver, e.g., the number of locations to which the robot moves from its original position. For example, by combining angle of arrival measurements with received signal strength measurements, the position of the beacon or object associated with the beacon could be determined on the basis of merely one measurement, for a single well-defined location of the receiver.

In some scenarios, an orientation of the beacon may be determined. This may be achieved on the basis of measurements performed by an orientation sensor of the beacon, e.g., an accelerometer and/or a gyroscopic sensor. Results of these measurements may be reported to the receiver (e.g., by the signals transmitted by the beacon). The orientation of the beacon may then in turn be used for determining the orientation of an object to which the beacon is attached or otherwise associated.

Several positions can be defined by either moving the same beacon manually to a new place or by using several transmitting beacons. When using multiple beacons, every beacon may be uniquely identifiable, e.g., based on unique identifier transmitted by the beacon.

Configuring and administrating the metadata associated with each beacon is done using a software application. The possibility to physically move the transmitting beacons makes it intuitive for an operator to define new positions of importance within the robot's coordinate system. By physically placing or moving the beacon(s) this can be achieved in an intuitive manner, without requiring specific expertise on robotic systems. When using multiple beacons, the positions of theses beacons can be measured in a single automated process. Further, the beacon(s) can also be used to define an orientation of an object.

Exemplary use cases of the illustrated concepts include initial configuration of a robot cell. For this purpose, an operator may place the beacons at certain locations to define target positions and/or other important positions for controlling movement of the robot. In a similar manner, one or more of the beacons could be moved to other locations for reconfiguring the cell of the robot. According to a further use case, the beacons may be used for real-time positioning of a work objects as it is processed during production. For this purpose, one or more beacons may be attached to the work object. If the location of the work object varies, the corresponding position in the coordinate system of the robot can be updated accordingly. This may also be applied with respect to other kinds of objects, e.g., a container holding parts to be picked up by the robot or a container to which the robot should release a picked up part.

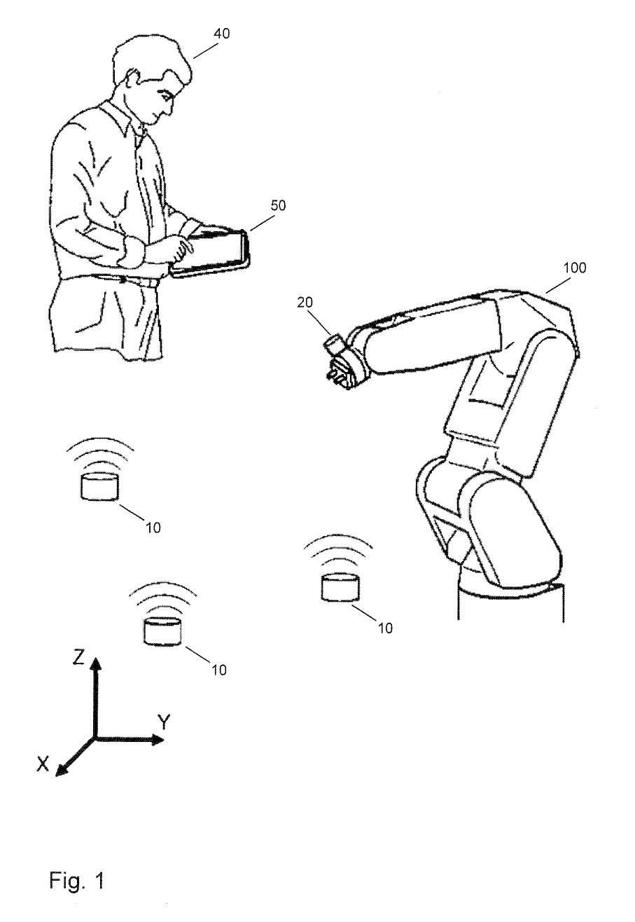

FIG. 1 shows an exemplary scenario involving an industrial serial robot 100 including a receiver unit 20 mounted on a robotic arm of the robot 100 and three beacons 10 which define a cell of the robot 100. Here, the term “cell” is used to denote a complete system including the robot 100 and peripherals, such as a part positioner and/or components of a safety environment. The cell may thus be defined in terms of positions which are relevant for operation of the robot, e.g., target positions, positions to be avoided, or boundary positions. The positions may be used for controlling movement of the robot 100.

Further, FIG. 1 shows a controller 50 which may be used for controlling operation of the robot 100. As illustrated, the controller 50 may be a handheld computer device, such as a tablet computer or smartphone. However, other types of controllers may be used as well, e.g., a stationary control terminal. Using the controller. An operator 40 may instruct the system to define three positions relative to the coordinate system (x, y, z) of the robot 100. This may for example be accomplished through an app executed by the controller 50, i.e., by through software installed on the controller. For defining the three positions, the receiver 20 receives signals from the beacons 10. The received signals are then used to measure the position of each beacon 10 in the coordinate system of the robot 100. For this purpose, the robot 100, in particular the robotic arm of the robot 100 may sequentially move the receiver 20 to three different locations where the signals from the beacons 10 are received. From the signals received at the different positions, the receiver 20 and/or the controller 50 may then automatically calculate and return coordinates which define the positions of the beacons 10 in the coordinate system of the robot 100. These positions may then be used for controlling operation, in particular movement, of the robot 100.

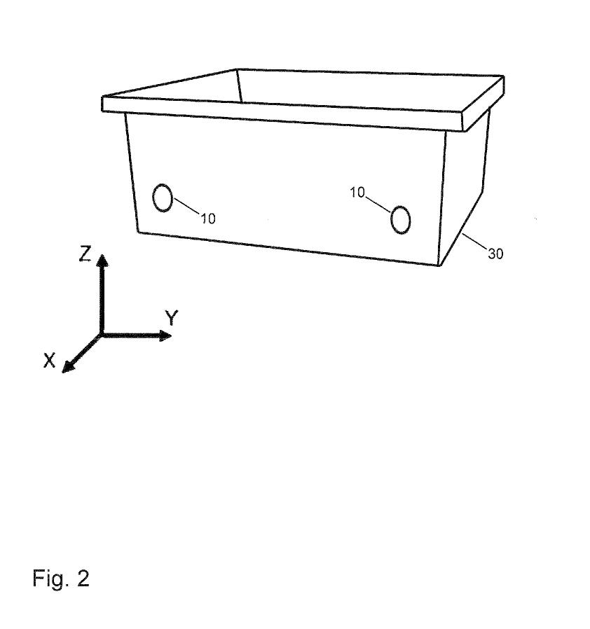

FIG. 2 shows an exemplary use case in which two beacons 10 are attached to a box 30 (or other type of container). For attaching the beacons tend to the box 30, the beacons 10 may for example be provided with a non-permanent adhesive. Alternatively or in addition, the beacons 10 could be provided with a suction cup or a magnet.

The box 30 may for example have the purpose of holding parts to be picked up by the robot 100 or the purpose of receiving parts picked up and then released by the robot 100. By means of the two beacons 10, the position of the box 30 can be defined in the coordinate system of the robot 100. For example, the position of the box 30 could be derived by averaging the positions of the two beacons 10. Further, the two beacons 10 can indicate the width of the box 30, e.g., by placing them close to the edges of the box 30. Still further, the two beacons 10 can be used to indicate an orientation of the box 30. For example, a tilt angle of the box 30 around the x-axis could be indicated by the difference of the z-coordinates of the positions of the two beacons 10 and the difference of the y-coordinates of the two beacons 10.

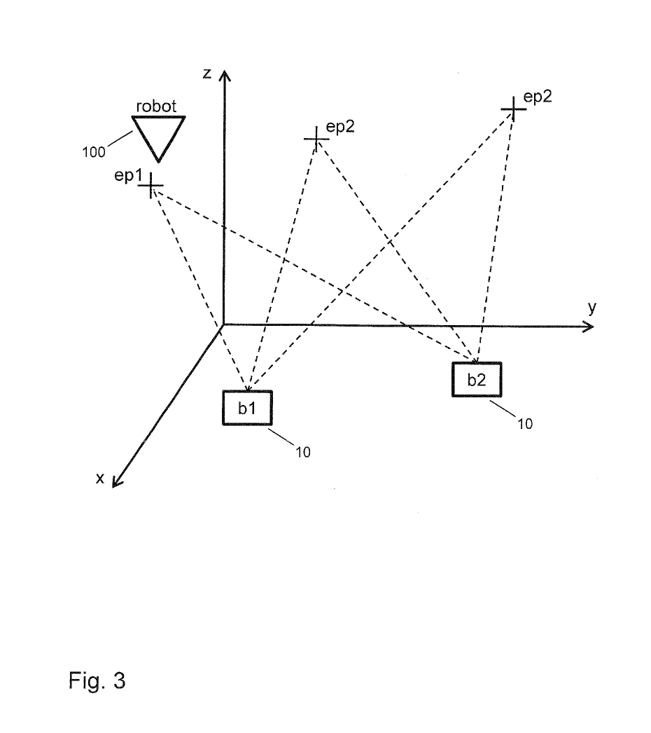

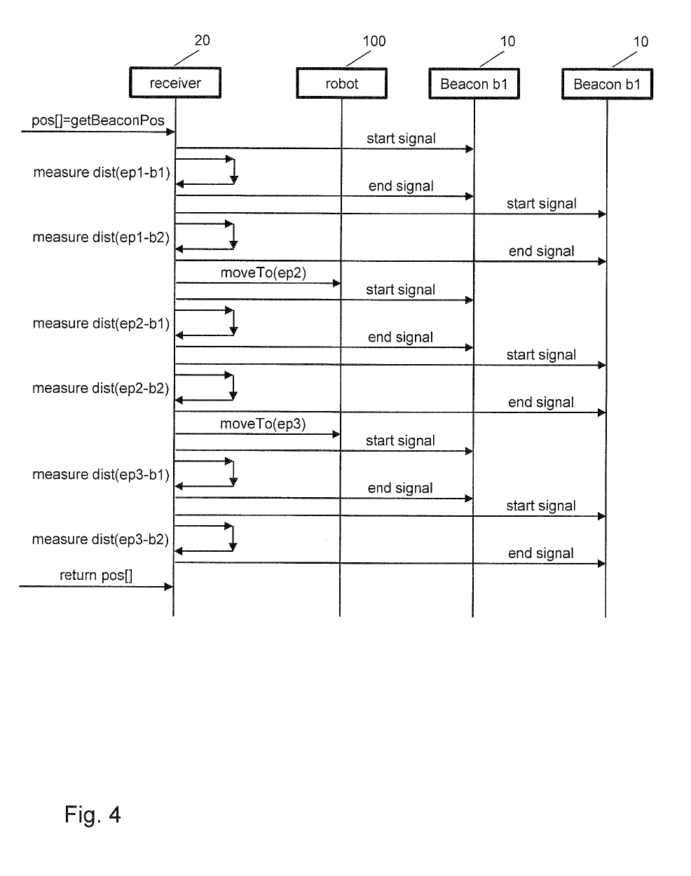

FIGS. 3 and 4 show an example of how the positions of two beacons within the coordinate system of the robot 100 can be calculated. FIG. 2 shows a setup as assumed in this example. This setup involves two beacons 10 (denoted b1 and b2) which are placed at different physical locations. Further, FIG. 2 shows three different locations of placing the receiver 20 (denoted by ep1, ep2, and ep3). FIG. 4 shows exemplary processes which may be performed to define positions in the coordinate system of the robot.

As illustrated by the processes of FIG. 4, an instruction to get the positions of the beacons 10 (denoted by “pos[]=getBeaconPos”) is provided to the receiver 20. For example, this instruction may be sent by the controller 50. At this point, the receiver 20 is located at the location ep1. The beacon b1 then sends its signal. As illustrated, this may be controlled by the receiver 20 sending an instruction to start sending the signal (denoted by “start signal”) to the beacon b1 and by the receiver 20 sending an instruction to stop sending the signal (denoted by “stop signal”) to the beacon b1. The receiver 20 receives the signal from the beacon b1 and calculates the distance between the receiver 20 and the beacon b1. This may be accomplished based on the received strength of the signal from the beacon b1. Alternatively or in addition, the receiver 20 may also save a result of a measurement on the signal from the beacon b1 for later use. Then the beacon b2 transmits its signal. As illustrated, this may be controlled by the receiver 20 sending an instruction to start sending the signal (denoted by “start signal”) to the beacon b2 and by the receiver 20 sending an instruction to stop sending the signal (denoted by “stop signal”) to the beacon b2. The receiver 20 receives the signal from the beacon b2 and calculates the distance between the receiver 20 and the beacon b2. This may be accomplished based on the received strength of the signal from the beacon b2. Alternatively or in addition, the receiver 20 may also save a result of a measurement on the signal from the beacon b1 for later use.

The robot then moves the receiver 20 to the location ep2. As illustrated, this may be accomplished by the receiver 20 sending a corresponding instruction (denoted by “moveTo(ep2)”) to the robot 100. This instruction can be sent directly from the receiver 20 to the robot 100 or indirectly via the controller 50. For the location ep2, the above measurements on the signals from the beacons are repeated. Accordingly, the beacon b1 again sends its signal. As illustrated, this may be controlled by the receiver 20 sending an instruction to start sending the signal (denoted by “start signal”) to the beacon b1 and by the receiver 20 sending an instruction to stop sending the signal (denoted by “stop signal”) to the beacon b1. The receiver 20 receives the signal from the beacon b1 and calculates the distance between the receiver 20 and the beacon b1. This may be accomplished based on the received strength of the signal from the beacon b1. Alternatively or in addition, the receiver 20 may also save a result of a measurement on the signal from the beacon b1 for later use. Then the beacon b2 transmits its signal. As illustrated, this may be controlled by the receiver 20 sending an instruction to start sending the signal (denoted by “start signal”) to the beacon b2 and by the receiver 20 sending an instruction to stop sending the signal (denoted by “stop signal”) to the beacon b2. The receiver 20 receives the signal from the beacon b2 and calculates the distance between the receiver 20 and the beacon b2. This may be accomplished based on the received strength of the signal from the beacon b2. Alternatively or in addition, the receiver 20 may also save a result of a measurement on the signal from the beacon b1 for later use.

The robot then moves the receiver 20 to the location ep3. As illustrated, this may be accomplished by the receiver 20 sending a corresponding instruction (denoted by “moveTo(ep2)”) to the robot 100. This instruction can be sent directly from the receiver 20 to the robot 100 or indirectly via the controller 50. For the location ep3, the above measurements on the signals from the beacons are repeated. Accordingly, the beacon b1 again sends its signal. As illustrated, this may be controlled by the receiver 20 sending an instruction to start sending the signal (denoted by “start signal”) to the beacon b1 and by the receiver 20 sending an instruction to stop sending the signal (denoted by “stop signal”) to the beacon b1. The receiver 20 receives the signal from the beacon b1 and calculates the distance between the receiver 20 and the beacon b1. This may be accomplished based on the received strength of the signal from the beacon b1. Alternatively or in addition, the receiver 20 may also save a result of a measurement on the signal from the beacon b1 for later use. Then the beacon b2 transmits its signal. As illustrated, this may be controlled by the receiver 20 sending an instruction to start sending the signal (denoted by “start signal”) to the beacon b2 and by the receiver 20 sending an instruction to stop sending the signal (denoted by “stop signal”) to the beacon b2. The receiver 20 receives the signal from the beacon b2 and calculates the distance between the receiver 20 and the beacon b2. This may be accomplished based on the received strength of the signal from the beacon b2. Alternatively or in addition, the receiver 20 may also save a result of a measurement on the signal from the beacon b1 for later use.

At this point, the receiver 20 has determined the distances between the receiver 20 and the beacon b1 and the distances between the receiver 20 and the beacon b2 for each of the three different locations of the receiver 20. Using these distances, the positions of the beacons b1 and b2 in the coordinate system of the robot can be determined, e.g. by triangulation and/or trilateration based on the measurements for each beacon at each position.

It is noted that in the example of FIG. 4, the different beacons 10 are controlled to transmit only one at a time. This corresponds to a time division-based multiplexing scheme. However, other multiplexing schemes may be applied in addition or as an alternative to avoid collisions of signals from a plurality of coexisting beacons.

It is noted that while the above-mentioned examples refer to a scenario where a receiver mounted on the robot is used for receiving signals from one or more beacons, it would also be possible to implement the illustrated concepts on the basis of signals transmitted in the opposite direction, by using a transmitter mounted on the robot to send the signals and one or more receivers, each placed at a desired physical location, to receive the signals.

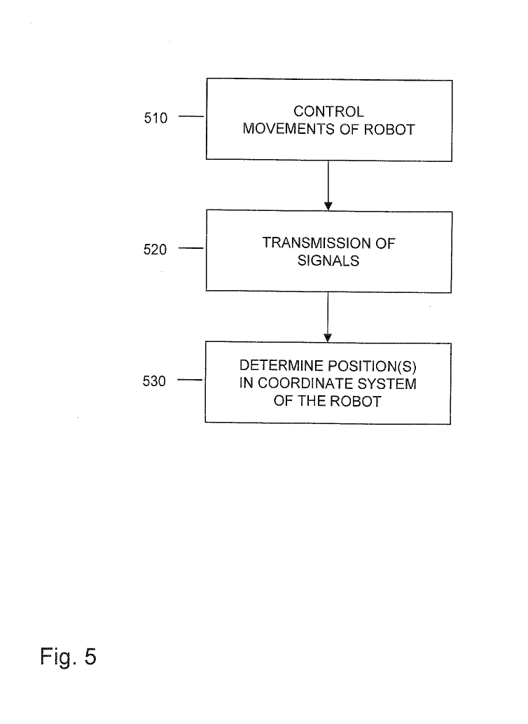

FIG. 5 shows a flowchart illustrating a method which may be used for defining one or more positions in a coordinate system of a robot according to the concepts as described above. The one or more positions may include a position of an object, e.g., a position of the box 30. Alternatively or in addition, the one or more positions may include a target position for the robot. Alternatively or in addition, the one or more positions may include a position to be avoided by the robot. However, it is noted that any other kind of position in the coordinate system of the robot could be defined by means of the at least one beacon.

The robot may for example correspond to the above-mentioned robot 100. The method may for example be implemented by a device mounted on the robot, such as the above-mentioned receiver unit 20, or a device which collects measurements from one or more receivers, e.g., from the above-mentioned receiver unit 20 or form one or more receivers which receive signals from a transmitter mounted on the robot. If a processor based implementation of the device is utilized, at least a part of the steps of the method may be performed and/or controlled by one or more processors of the device. In some scenarios, at least a part of the steps of the method may be performed and/or controlled by one or more processors outside the device, e.g., by one or more processors of an external controller, such as the controller 50, by one or more processors of the robot.

At step 510, movements of the robot may be controlled. For example, this may involve sending control signals to the robot. In some scenarios, the movements of the robot could also be controlled by an external controller of the robot, such as the above-mentioned controller 50. The control operations of step 510 may in particular involve operating the robot to place a first device mounted on the robot at multiple different physical locations.

At step 520, signals are transmitted between a first device, which is mounted on the robot, and at least one second device. The signals may be transmitted from the at least one second device to the first device. For example, the at least one second device may correspond to at least one beacon sending the signals, such as the above-mentioned beacons 10, and the first device may correspond to or include a receiver which receives the signals from the beacons, such as the above-mentioned receiver unit 20. Further, the signals can be transmitted from the first device to the at least one second device. For example, the first device may correspond to or include a transmitter sending the signals and the at least one second device may correspond to or include a receiver receiving the signals. If multiple second devices are used, the each of the second devices may correspond to or include a receiver receiving the signals.

The signals may be ultrasonic signals, radio signals, or radar signals. However, other signal types could be used as well, such as laser based signals or infrared light based signals. Further, it is also possible to use a combination of the above-mentioned signal types.

The at least one second device is placed at a certain physical location. If multiple second devices are used, each of the second devices is placed at a certain physical location. Multiple second devices can be used to define multiple positions in the coordinate system of the robot. Further, multiple second devices can be used to define one or more orientations in the coordinate system of the robot. Placing of the second devices can be accomplished by an operator of the robot, in accordance with one or more desired positions to be defined in the coordinate system of the robot.

In some scenarios, the robot is operated to place the first device at multiple different physical locations, e.g., in accordance with the control operations of step 510. In this case, the signals may be transmitted for each of the different locations of the first device.

At step 530, the one or more positions in the coordinate system of the robot are determined based on the transmitted signals.

In some scenarios, if the signals are transmitted for multiple different physical locations of the first device, the one or more positions in the coordinate system of the robot may be determined based on the signals transmitted for the different locations of the first device. This may for example involve that for each of the different locations of the first device the signals are evaluated to determine a distance between the first device and the at least one second device. The one or more positions in the coordinate system of the robot can then be determined based on the distances evaluated for the different locations of the first device, e.g., by triangulation and/or trilateration.

In some scenarios, an angle at which the signals are transmitted can be determined. For example, if the at least one second device corresponds to or includes at least one beacon sending the signals and the first device corresponds to or includes a receiver for receiving the signals from the at least one beacon, the angle can be determined as an angle at which the receiver receives the signals from the at least one beacon. For example, the receiver could support direction dependent-reception of the signals, e.g., by a multi-antenna technology. If the first device corresponds to or includes a transmitter sending the signals, the angle can be determined as an angle at which the transmits the signals. For example, the transmitter could support a beamforming technology which allows for focusing the signals into a desired angular direction from the transmitter and scanning different transmit angles.

Based on the angle, the one or more positions in the coordinate system of the robot can then be determined. When combining measurement of the angle with measurement of the distance between the first device and the second device, it may be sufficient to measure the angle and the distance for only one physical location of the first device. However, also in this case the first device could be placed at multiple different physical locations, e.g., in order to improve accuracy.

In some scenarios, the at least one second device could be equipped with an orientation sensor, e.g., based on an accelerometer and/or a gyroscope, and measurements by the orientation sensor of the at least one second device could be used as a basis for determining an orientation of the at least one second device in the coordinate system of the robot. This orientation may then be used for deriving the orientation of an object to which the at least one second device is attached or otherwise associated. For example, in the example of FIG. 2 the orientation of one of the beacons 10 (or of both beacons 10) could be used to determine the orientation of the box 30. The at least one second device may report the measurements by the orientation sensor to the first device or some other device, e.g., by encoding a measurement report in the signals transmitted by the at least one beacon.

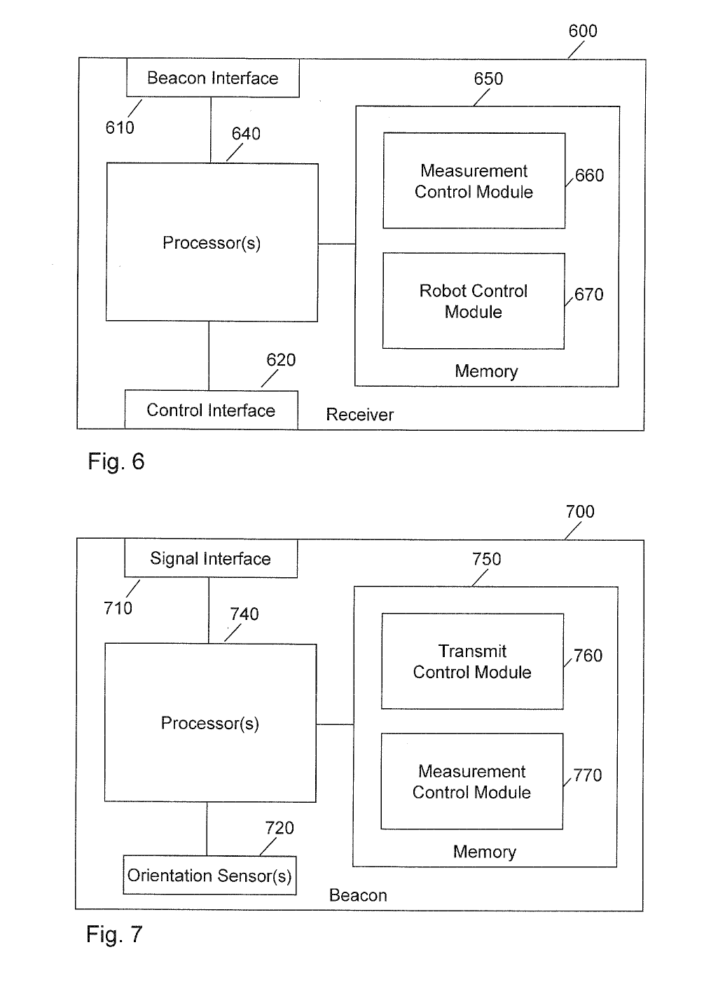

FIG. 6 shows a block diagram for schematically illustrating a processor based implementation of a receiver which may be utilized for implementing the above concepts. The receiver may for example correspond to the above-mentioned receiver 20.

As illustrated, the receiver includes a beacon interface 610. The receiver may utilize the beacon interface 610 for receiving signals from one or more beacons, such as the beacons 10. The beacon interface 610 may support reception of ultrasonic signals, radio signals, and/or of radar signals. In some scenarios, the beacon interface 610 may support directional reception of the signals, e.g., based on a multi-antenna technology. Further, it is noted that in some scenarios the beacon interface 610 may also support bidirectional transmission. In this case, the beacon interface 610 could also be used for sending instructions or other control information to the beacon(s), such as the above-mentioned instructions to start or stop sending signals.

As further illustrated, the receiver is provided with a control interface 620. The control interface 620 may be used for connecting the receiver to an external controller, such as the above-mentioned controller 50. Further, the control interface 620 may be used for connecting the receiver to a robot on which the receiver is mounted. The control interface 620 can be a wireless interface, e.g., a radio interface, or a wire-based interface.

Further, the receiver is provided with one or more processors 640 and a memory 650. The beacon interface 610 and the memory 650 are coupled to the processor(s) 640, e.g., using one or more internal bus systems of the receiver 20.

The memory 650 includes program code modules 660, 670 with program code to be executed by the processor(s) 640. In the illustrated example, these program code modules include a measurement control module 660 and a robot control module 670.

The measurement control module 660 may implement functionalities of controlling the above-mentioned functionalities of performing and evaluating measurements on the basis of signals received from one or more beacons. The robot control module 670 may implement the above-described functionalities of controlling operation of the robot, e.g., in order to please the receiver at different physical locations.

It is to be understood that the structures as illustrated in FIG. 6 are merely exemplary and that the receiver may also include other elements which have not been illustrated, e.g., structures or program code modules for implementing known functionalities of an ultrasonic, radio, or radar receiver.

FIG. 7 shows a block diagram for schematically illustrating a processor based implementation of a beacon which may be utilized for implementing the above concepts. The beacon may for example correspond to one of the above-mentioned beacons 10.

As illustrated, the beacon includes a signal interface 710. The beacon may utilize the signal interface 710 for sending signals to a receiver mounted on a robot, such as the above-mentioned receiver 20. The signal interface 710 may support sending of ultrasonic signals, of radio signals, and/or of radar signals. Further, it is noted that in some scenarios the signal interface 710 may also support bidirectional transmission. In this case, the signal interface 710 could also be used for receiving instructions or other control information, such as the above-mentioned instructions to start or stop sending signals.

In some scenarios, the beacon may also include an orientation sensor 720. The orientation sensor may for example be based on an accelerometer and/or on a gyroscope.

Further, the beacon is provided with one or more processors 740 and a memory 750. The signal interface 710 and the memory 750, and optionally the orientation sensor 720, are coupled to the processor(s) 740, e.g., using one or more internal bus systems of the beacon.

The memory 750 includes program code modules 760, 770 with program code to be executed by the processor(s) 740. In the illustrated example, these program code modules include a transmit control module 760 and a measurement control module 770.

The transmit control module 760 may implement the above described functionalities for sending the signals to the receiver mounted on the robot. The measurement control module 770 may implement functionalities for performing measurements locally at the beacon itself, e.g., using the orientation sensor 720.

It is to be understood that the structures as illustrated in FIG. 7 are merely exemplary and that the beacon may also include other elements which have not been illustrated, e.g., structures or program code modules for implementing known functionalities of an ultrasonic and/or radio transmitter.

Further, it is noted that similar structures as shown in FIGS. 6 and 7 could also be used in a scenario where the positions in the coordinate system of the robot are defined based signals transmitted from a first device mounted on the robot to at least to at least one second device which is placed at a certain physical location to define the position in the coordinate system of the robot. In this case, the beacon interface 610 could be used for sending the signals, and the signal interface 710 could be used for receiving the signals. Further, the signal interface 710 could be used for reporting measurements on the signals to the first device or to some other device. Moreover, the memory 650 could include a transmit control module for implementing the functionalities for transmitting the signals. Further, the memory 750 could include a reception control module to implement the functionalities for receiving the signals from the first device mounted on the robot, and the measurement control module 770 could then may implement functionalities for performing measurements on the received signals.

As can be seen, the concepts according to embodiments as explained above allow for improving known technologies for determining positions of objects, as for example needed in operation of an industrial robot or similar device. Further, the concepts according to embodiments as explained above allow for providing a solution which is easy to use, which achieves high localization accuracy and high time efficiency, and which works even for multiple positions, e.g., on multiple, randomly placed objects.

It is to be understood that the concepts as explained above are susceptible to various modifications. For example, the concepts could be applied in connection with various kinds of robotic systems. Further, the concepts may utilize various types of beacons and receivers.

1. A method of defining one or more positions in a coordinate system of a robot, the method comprising:
operating the robot to place a first device mounted on the robot at multiple different physical locations;
for each of the different locations of the first device, transmitting signals between the first device and at least one second device placed a certain physical location; and
based on the signals transmitted for the different locations of the first device, determining one or more positions in the coordinate system of the robot.

2. The method according to claim 1,
wherein the at least one second device comprises one or more beacons transmitting the signals,
wherein the first device comprises a receiver which receives the signals from the one or more beacons.

3. (canceled)

4. The method according to claim 1, comprising:
for each of the different locations of the first device, evaluating the signals to determine a distance between the first device and the at least one second device; and
based on the distances evaluated for the different locations of the first device, determining said one or more positions in the coordinate system of the robot.

5. The method according to claim 1, comprising:
based on the signals received for the different locations of the first device, determining an orientation of an object in the coordinate system of the robot.

6. The method according to claim 1, comprising:
determining an angle at which the signals are transmitted between the first device and the at least one second device; and
based on the angle, determining said one or more positions in the coordinate system of the robot.

7. The method according to claim 1, comprising:
based on measurements by an orientation sensor of the at least one second device, determining an orientation of the at least one second device in the coordinate system of the robot.

8. The method according to claim 1,
wherein said one or more positions comprise a position of an object.

9. The method according to claim 1,
wherein said one or more positions comprise a target position for the robot and/or a position to be avoided by the robot.

10. (canceled)

11. The method according to claim 1,
wherein the signals comprise at least one of ultrasonic signals, radio signals, and radar signals.

12. A system, comprising:
a first device mounted on a robot and configured for transmission of signals between the first device and at least one second device placed at a certain physical location; and
at least one processor configured to
operate the robot to place the first device at multiple different physical locations;
for each of the different locations of the first device, control transmission of signals between the first device and the at least one second device; and
based on the signals transmitted for the different locations of the first device, determine one or more positions in the coordinate system of the robot.

13. The system according to claim 12,
wherein the first device and the at least one processor are part of the same device.

14. The system according to claim 12,
wherein the system further comprises the at least one second device.

15. The system according to claim 12,
wherein the at least one processor is configured to perform the steps of a method according to claim 1.

16. A robot, comprising:
a first device mounted on the robot and configured for transmission of signals between the first device and at least one second device placed at a certain physical location; and
at least one processor configured to:
operate the robot to place the first device at multiple different physical locations;
for each of the different locations of the first device, control transmission of signals between the first device and the at least one second device; and
based on the signals transmitted for the different locations of the first device, determine one or more positions in the coordinate system of the robot.

17. A non-transitory computer readable medium comprising program code to be executed by at least one processor for controlling a robot, whereby execution of the program code causes the at least one processor to:
operate the robot to place the first device at multiple different physical locations;
for each of the different locations of the first device, control transmission of signals between the first device and the at least one second device; and
based on the signals transmitted for the different locations of the first device, determine one or more positions in the coordinate system of the robot.
